(19) United States
(12) Patent Application Publication
(10) Pub. No.: US 2007/0159780 A1
(43) Pub. Date: Jul. 12, 2007

(54) Casing structure and function changing method thereof

(76) Inventors: Chun-Yi Lai, Jhongli City (TW); Long Wang, Jiangsu (CN); Jung Hua Yeh, Jiangsu (CN)

Correspondence Address: ROSENBERG, KLEIN & LEE, 3458 ELLICOTT CENTER DRIVE-SUITE 101, ELLICOTT CITY, MD, 21043, US

(21) Appl. No.: 11/506,803

(22) Filed: Aug. 21, 2006

(30) Foreign Application Priority Data
Jan. 9, 2006 (TW) 095100788

(51) Int. Cl. G06F 1/16

(52) U.S. Cl. 361/683

(57) ABSTRACT

A casing structure and function changing method thereof are disclosed. The casing structure has a casing space divided into a first space and a second space. The first space is provided for accommodating an electronic apparatus like a laptop computer while the second space is provided for storing a brace member. The brace member can be turned into a temporary holder for supporting the electronic apparatus as well as a computer table of the laptop computer.

### FIELD OF THE INVENTION

The present invention relates to a casing structure and function changing method thereof, and more particularly to a brace member added in a casing structure.

### BACKGROUND OF THE INVENTION

More and more people are using laptops than desktop computers. People may use their laptop computers in public places like airports, railroad/bus stations, department stores and coffee bars. People may use their knees to be temporary computer tables for operating their laptop computers. However, the poses for keying keyboards and for watching screens of these laptop computers may not meet ergonomics when these laptop computers are put on user's knees.

Referring to FIG. 1, a schematic diagram illustrates operating a conventional laptop computer. As shown in FIG. 1, a user 10 usually sits on a public seat 11 to use the laptop computer. Without any table, the user 10 then puts the laptop computer 12 on the user's knees for operation. However, because the laptop computer 12 is put on the knees, the user 10 must look askance 13 the laptop computer 12 that causes inconvenience. An image showed from the laptop computer 12 is not clear and the eyesight of the user 10 may be harmed when the user 10 looks askance the screen of the laptop computer 12. In addition, the laptop computer 12 is close to the user 10 when the laptop computer 12 is put on the knees. The user 10 operates the laptop computer at a direction 14 that must be toward the keyboard of the laptop computer 12 from a top. This is uncomfortable and can be a tiring exercise when the user 10 operates the laptop computer 12.

Therefore, it will be an important issue for providing a comfortable operating environment in public places for a laptop computer user as well as working at homes.

### SUMMARY OF THE INVENTION

In view of the foregoing issues, an objective of the present invention is to provide a casing structure and function changing method thereof. A conventional notebook case is then improved to become a holder for a portable computer while keeping the carry function. It should be noted that the casing structure disclosed by the present invention can further accommodate other electronic apparatus and can be turned into a holder or table legs for supporting a portable laptop computer.

The casing structure comprises a casing body, at least one partition layer and a brace member. The casing body is preferably a computer case, a baggage or a casing space. The partition layer is disposed in the casing space to partition the casing space into a first space and a second space. The first space is provided for accommodating an electronic apparatus while the second space is provided for storing the brace member. In the second space, the brace member has at least one end which is pivotally coupled to a plane of the partition layer. When the second space is opened, the brace member can be turned into a holder or table legs for supporting the casing body.

In addition, the brace member comprises a first brace and a second brace. The first brace comprises a first end which is pivotally coupled to the plane of the partition layer. The second brace also has a second end which is pivotally coupled to the plane of the partition layer as well as the first brace.

Moreover, the first brace has a first supporting cylinder which is extended from the first end. The second brace also has a second supporting cylinder which is extended from the second end. The first brace has a third supporting cylinder which is extended from a third end pivotally coupled to the plane of the partition layer, and the second brace has a fourth supporting cylinder which is extended from a fourth end pivotally coupled to the plane of the partition layer.

Furthermore, the interior walls of the supporting cylinders have a first extension cylinder, a second extension cylinder, a third extension cylinder and a fourth extension cylinder respectively. The extension cylinders can be pulled from or retained in the supporting cylinders. To hook the extension cylinders after pulling, the outer walls of the supporting cylinders have a first hooking member, a second hooking member, a third hooking member and a fourth hooking member. The interior wall of any extension cylinder has a hole and an elastic body. When the extension cylinder is pulled from the interior wall of the supporting cylinder, the elastic body is sprung to protrude a protruding portion of the elastic body for engaging with a side edge of the hooking member. In order to facilitate extension cylinder being retracted into the interior wall of the supporting cylinder, the side edge of the hooking member has a notch and a sliding groove extending from the notch toward the interior wall of the hooking member. When the extension cylinder is pressed back by an external force into the interior wall of the supporting cylinder, the protruding portion of the elastic body is therefore pressed through the notch back into the interior wall of the extension cylinder along the sliding groove.

Under the foregoing disclosure of the casing structure having a plurality of supporting cylinders pivotally coupled to a plane of the casing body, the present invention also discloses a function changing method for the casing structure to be turned into the holder or the table legs. The function changing method comprises the following steps:
(a) An opening of the casing body is opened to allow the supporting cylinders to be showed so as to perform the function changing.
(b) The supporting cylinders are pivoted to allow the supporting cylinders corresponding to the casing body to form a standing status so that the casing body could set upon the floor.
(c) The extension cylinders are pulled from the interior walls of the supporting cylinders to adjust heights for the casing body.
(d) After adjusting the required heights, the extension cylinders are hooked at a position of the supporting cylinders through the hooking members collared on the outer walls of the supporting cylinders in advance and holes and elastic bodies predetermined in the interior walls of the extension cylinders.

In the function changing method, the casing body is preferably a computer case or a baggage. When the extension cylinder is pulled from the interior wall of the supporting cylinder, the elastic body is sprung to protrude a protruding portion of the elastic body from the hole to hook at a side edge of the hooking member. In order to facilitate extension cylinder being retracted into the interior wall of the supporting cylinder, the side edge of the hooking member has a notch and a sliding groove extending from the notch toward the interior wall of the hooking member. When the extension cylinder is pressed by an external force into the interior wall of the supporting cylinder, the protruding portion of the elastic body is pressed through the notch back into the interior wall of the extension cylinder along the sliding groove.

The invention can be more fully understood by reading following detailed description of the preferred embodiment with reference made to the accompanying drawings.

### BRIEF DESCRIPTION OF THE DRAWINGS

FIG. 1 is a schematic diagram of operating a conventional laptop computer;

FIG. 2 is a schematic diagram of a casing structure according to an embodiment of the present invention;

FIG. 3 is a side view block of a casing structure according to an embodiment of the present invention;

FIG. 4 is a bottom view of a casing structure according to an embodiment of the present invention;

FIG. 5 is a perspective drawing of a brace member according to an embodiment of the present invention;

FIG. 6 is a structural drawing of a supporting cylinder according to an embodiment of the present invention;

FIG. 7 is a schematic diagram of an extension cylinder and a supporting cylinder according to an embodiment of the present invention;

FIG. 8 is another perspective view of an extension cylinder and a supporting cylinder according to an embodiment of the present invention;

FIG. 9 is a flowchart of a function changing method for a casing structure according to an embodiment of the present invention; and

FIG. 10 is a schematic diagram of adding a storage trough and pulling function in a brace member according to an embodiment of the present invention.

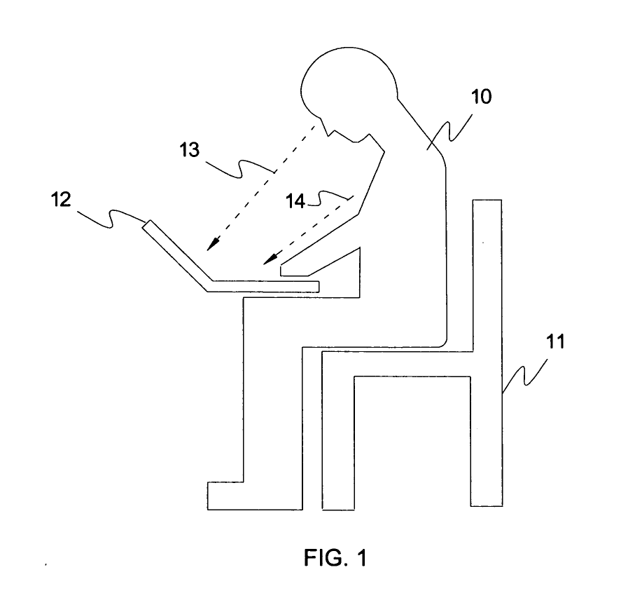

### DETAILED DESCRIPTION OF THE PREFERRED EMBODIMENTS

Refer to the related figures for a casing structure according to a preferred embodiment of the present invention, wherein the same elements are described by the same reference numerals.

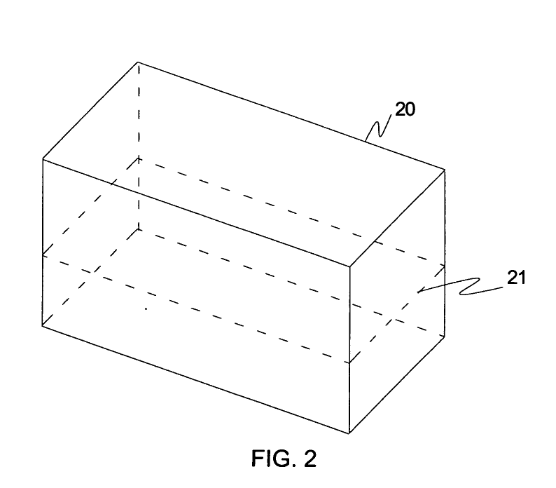

FIG. 2 is a schematic diagram illustrating a casing structure according to an embodiment of the present invention. As shown in FIG. 2, the casing structure 2 comprises a casing body 20, at least one partition layer 21 and a brace member (not shown).

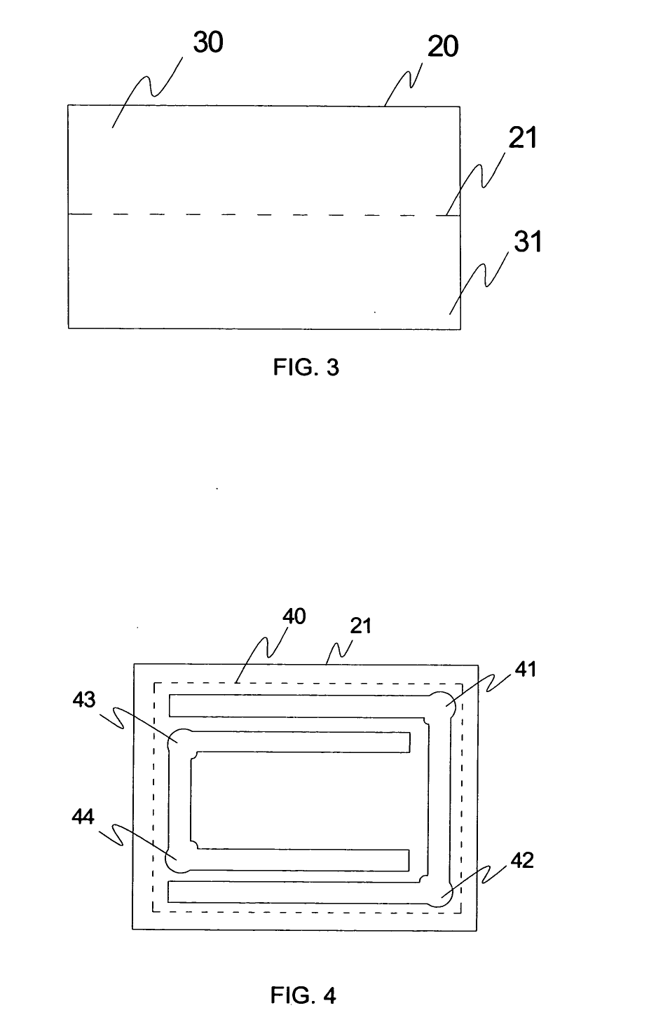

FIG. 3 is a side view according to FIG. 2. As shown in FIG. 2, the casing body 20 has a casing space that is partitioned by the partition layer 21 into a first space 30 and a second space 31. The first space 30 is provided for accommodating an electronic apparatus while the second space 31 is provided for disposing and storing the brace member.

FIG. 4 is a bottom view according to FIG. 2. As shown, the brace member 40 has at least one pivot end 41, 42, 43 or 44 pivotally coupled to a plane of the partition layer 21.

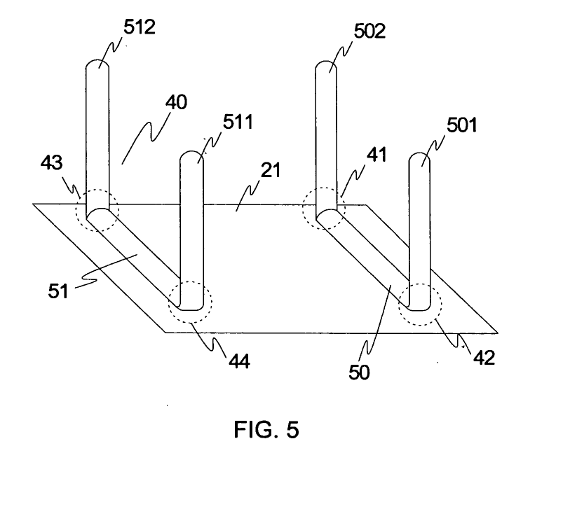

FIG. 5 is a perspective drawing illustrating the brace member according to FIG. 4. As shown, the brace member 40 comprises a first brace 50 and a second brace 51. Both the first brace 50 and the second brace 51 are pivotally coupled to the plane of the partition layer 21 respectively. The first brace 50 and the second brace 51 comprise a first supporting cylinder 501, a second supporting cylinder 511, a third supporting cylinder 502 and a fourth supporting cylinder 512. These supporting cylinders 501, 511, 502 and 512 are respectively extended from a first pivot end 42, a second pivot end 44, a third pivot end 41 and a fourth pivot end 43 that are taken to be the pivot ends on the plane of the partition layer 21.

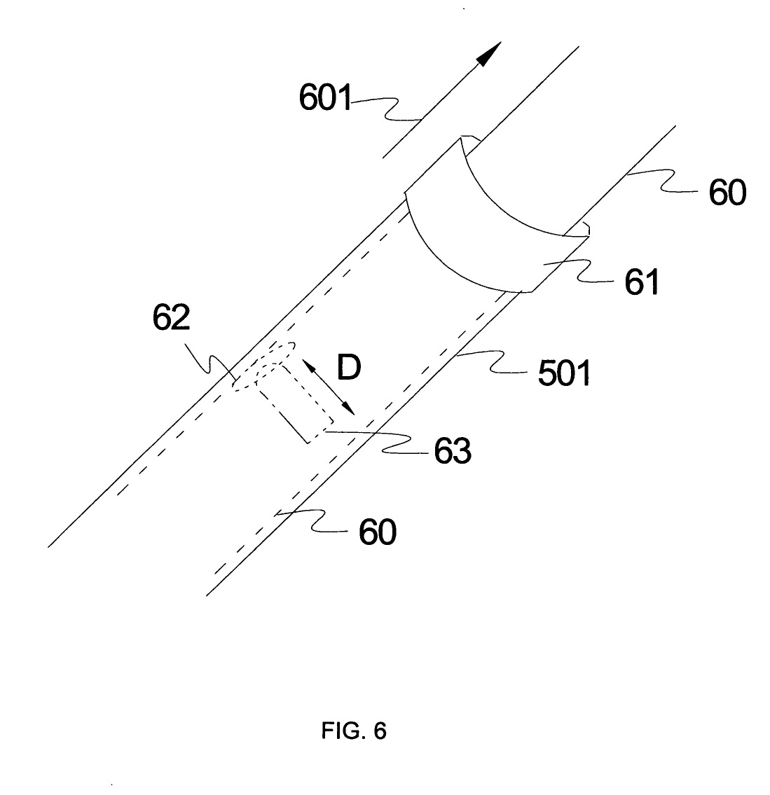

FIG. 6 is a structural drawing illustrating the first supporting cylinder according to FIG. 5. It should be noted that the first supporting cylinder as shown in FIG. 5 is taken to be an example for illustrating the function of each supporting cylinder. Other supporting cylinders are not repeatedly illustrated.

In FIG. 6, the interior wall of the first supporting cylinder 501 has a first extension cylinder 60 for telescopically outward extension along a direction 601. In addition, the outer wall surface of the first supporting cylinder 501 has a first hooking member 61 for fastening the first extension cylinder 60 after pulling. The interior wall of the first extension cylinder 60 has a hole 62. An elastic body 63 is provided in the hole 62. The elastic body 63 can perform elastic displacement toward the outside from the hole 62. The elastic body 63 then moves back and forth through the hole 62 at a direction D by the elastic force of the elastic body 63 per se and by the pressing force of the interior wall of the first supporting cylinder 501 pressing the elastic body 63. As shown in FIG. 6, because the position of the hole 62 of the first extension cylinder 60 is retained in the interior wall of the first supporting cylinder 501, the elastic body 63 is still pressed by the interior wall of the first supporting cylinder 501 and the elastic force of the elastic body 63 cannot be released.

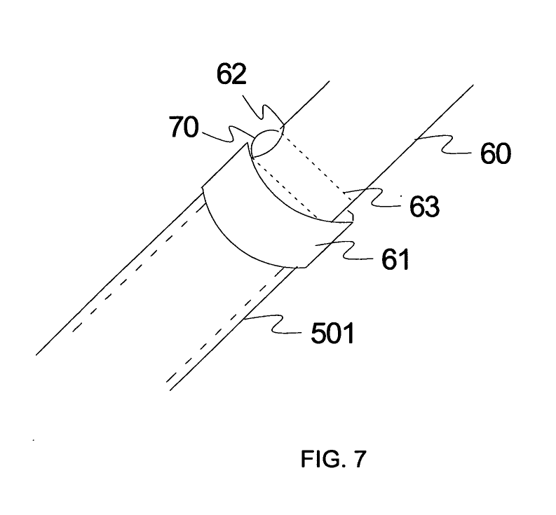

FIG. 7 is a schematic diagram illustrating the first extension cylinder 60 pulled from the interior wall of the first supporting cylinder 501 according to FIG. 6. As shown, when the first extension cylinder 60 is pulled from the interior wall of the first supporting cylinder 501 and the hole 62 on the interior wall of the first extension cylinder 60 is not covered by the interior wall of the first supporting cylinder 501, the elastic body 63 then releases the elastic force to achieve the elastic displacement. The elastic body 63 is then sprung from the hole 62 to protrude a protruding portion 70 of the elastic body 63 so as to hook at a side edge of the first hooking member 61.

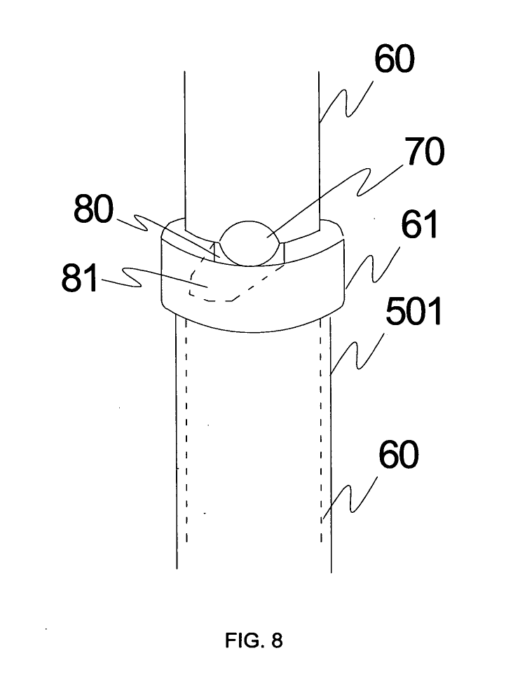

FIG. 8 is another perspective view of the drawing shown in FIG. 7. As shown, a side edge of the first hooking member 61 has a notch 80. A sliding groove 81 is extended from the notch 80 toward the interior wall of the first hooking member 61 from the notch 80. By implementing an external force to rotate the first hooking member 61, the protruding portion 70 of the elastic body 63 will be put into the notch 80 such that the protruding portion 70 is then pressed back to the interior wall of the first extension cylinder 60 along the sliding groove 81. The first extension cylinder 60 is then retained in the interior wall of the first supporting cylinder 501.

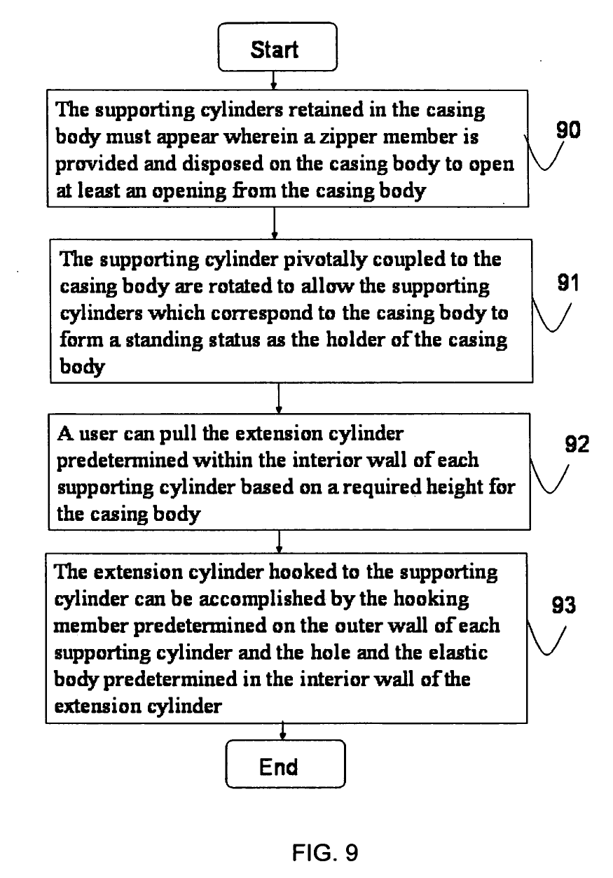

FIG. 9 is a flowchart illustrating the method of the function changing for a casing structure according to an embodiment of the present invention. According to the mentioned above, the casing body has a plurality of supporting cylinders in advance and these supporting cylinders are pivotally coupled to a plane of the casing body respectively. The method of the function changing for the casing structure comprises the following steps:

Step 90: firstly, the supporting cylinders retained in the casing body must appear wherein a zipper member is provided and disposed on the casing body to open at least an opening from the casing body.

Step 91: the supporting cylinder pivotally coupled to the casing body are rotated to allow the supporting cylinders which correspond to the casing body to form a standing status as the holder of the casing body.

Step 92: a user can pull the extension cylinder predetermined within the interior wall of each supporting cylinder based on a required height for the casing body.

Step 93: the extension cylinder hooked to the supporting cylinder can be accomplished by the hooking member predetermined on the outer wall of each supporting cylinder and the hole and the elastic body predetermined in the interior wall of the extension cylinder.

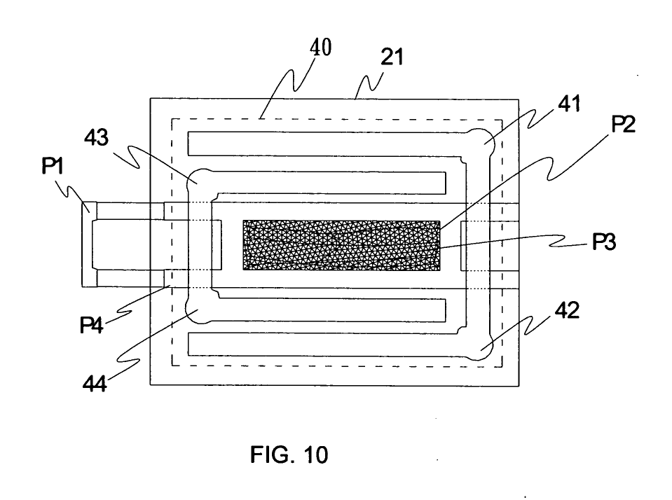

FIG. 10 is a schematic diagram illustrating the pulling function and a storage trough formed in the brace member shown in FIG. 4. The brace member 40 comprises the pivot ends 41, 42, 43 and 44 that are pivotally coupled to a plane of the partition layer 21. The brace member 40 has a pulling rod kit P4 for storing a pulling rod P1. The pulling rod kit P4 cooperates with the pulling rod P1 to provide the pulling function. Moreover, the partition layer 21 has a storage trough P2. The storage bag P3 is provided on the storage trough P2 for conveniently storing backup batteries or other things.

The casing body is preferably a computer case or a baggage. When the extension cylinders are pulled from the interior walls of the supporting cylinders, the elastic bodies are sprung from the holes to protrude the protruding portions to engage with the side edges of the hooking members for fastening the extension cylinders thereon.

In order to retract the holder or the legs, the hooking member is rotated to allow the protruding portion to be put within the notch disposed at the side edge of the hooking member, wherein a sliding groove is provided and extended from the notch toward the interior wall of the hooking member. When the protruding portion is put in the position of the notch, the extension cylinders are retracted into the supporting cylinders in order to press the protruding portion back to the interior wall of the extension cylinder along the sliding groove so that the extension cylinder can be retained in the interior wall of the supporting cylinder. Lastly, the supporting cylinder is pivoted to parallel with the plane of the partition layer, and the opening is closed to therefore store the holders or the table legs.

While the invention has been described by way of example and in terms of a preferred embodiment, it is to be understood that the invention is not limited thereto. It will be apparent to those skilled in this field that various modifications may be made in these embodiments without departing from the spirit and scope of the present invention.

What is claimed is:

1. A casing structure for accommodating an electronic apparatus, said casing structure comprising:
a casing body having a casing space;
at least one partition layer disposed in said casing space for partitioning said casing space into a first space and a second space, wherein said first space is for accommodating said electronic apparatus; and
a brace member disposed in said second space and having at least a first pivot end pivotally coupled to a plane of said partition layer.

2. The casing structure of claim 1, wherein said casing body is a computer case or a baggage.

3. The casing structure of claim 1, wherein said brace member comprises:
a first brace having said first pivot end pivotally coupled to said plane; and
a second brace having a second pivot end pivotally coupled to said plane.

4. The casing structure of claim 3, wherein said first brace has a first supporting cylinder extended from said first pivot end.

5. The casing structure of claim 3, wherein said second brace has a second supporting cylinder extended from said second pivot end.

6. The casing structure of claim 3, wherein said first brace has a third supporting cylinder extended from a third pivot end pivotally coupled to said plane.

7. The casing structure of claim 3, wherein said second brace has a fourth supporting cylinder extended from a fourth pivot end pivotally coupled to said plane.

8. The casing structure of claim 4, wherein the interior wall of said first supporting cylinder has a first extension cylinder.

9. The casing structure of claim 8, wherein the outer wall of said first supporting cylinder has a first hooking member for fastening said first extension cylinder after pulling.

10. The casing structure of claim 9, wherein the interior wall of said first extension cylinder has a hole and an elastic body, and when said extension cylinder is pulled from the interior wall of said first supporting cylinder, said elastic body being sprung to protrude a protruding portion of said elastic body from said hole to engage with a side edge of said first hooking member.

11. The casing structure of claim 10, wherein said side edge has a notch and a sliding groove extending from the notch toward the interior wall of said first hooking member, and when said first extension cylinder is retracted into the interior wall of said first supporting cylinder, said protruding portion being pressed through the notch back to the interior wall of said first extension cylinder along said sliding groove.

12. The casing structure of claim 1, wherein said plane of said partition layer has a pulling rod kit for disposing a pulling rod, and said pulling rod kit cooperating with said pulling rod to provide the pulling function for said casing body.

13. The casing structure of claim 1, wherein said plane of said partition layer has a storage trough, and a storage bag is provided on said storage trough for storing things.

14. A method of function changing for a casing structure having a casing body with a plurality of supporting cylinders pivotally coupled to a plane of said casing body respectively, said method comprising:
opening an opening of said casing body for showing said supporting cylinders; and
pivoting said supporting cylinders to allow said supporting cylinders corresponding to said casing body to form a standing status so as to be a holder for said casing body.

15. The method of function changing of claim 14, further comprising the steps:
pulling extension cylinders predetermined in the interior walls of said supporting cylinders to adjust a height for said casing body; and
fastening said extension cylinders at a position of said supporting cylinders to fix said height through hooking members collared on the outer walls of said supporting cylinders and elastic bodies and holes predetermined in the interior walls of said extension cylinders after pulling.

16. The method of function changing of claim 14, wherein said casing body is a computer case or a baggage.

17. The method of function changing of claim 15, wherein while pulling said extension cylinders from the interior walls of said supporting cylinders, said elastic bodies being sprung to protrude protruding portions of said elastic bodies from said holes to hook at side edges of said hooking members.

18. The method of function changing of claim 17, further comprising the step of forming notches on said side edges and sliding grooves extended from said notches toward the interior walls of said hooking members, when said extension cylinders being retained in the interior walls of said supporting cylinders, said protruding portions being pressed through said notches back to the interior walls of said extension cylinders along said sliding grooves.

19. The method of function changing of claim 14, further comprising the step of providing a pulling rod kit on said plane to store a pulling rod, wherein said pulling rod kit is cooperated with said pulling rod to provide the pulling function for said casing body.

20. The method of function changing of claim 14, further comprising the step of forming a storage trough on said plane, wherein a storage bag is provided on the storage trough for storing things.
